(19) United States
(12) Patent Application Publication
(10) Pub. No.: US 2013/0049546 A1
(43) Pub. Date: Feb. 28, 2013

(54) SPINDLE MOTOR

(71) Applicants: Young Sun Yoo, Gyunggi-do (KR); Yeol Choi, Gyunggi-do (KR); Yun Yeong Park, Gyunggi-do (KR)

(72) Inventors: Young Sun Yoo, Gyunggi-do (KR); Yeol Choi, Gyunggi-do (KR); Yun Yeong Park, Gyunggi-do (KR)

(73) Assignee: SAMSUNG ELECTRO-MECHNICS CO., LTD., Gyunggi-do (KR)

(21) Appl. No.: 13/304,264

(22) Filed: Nov. 23, 2011

(30) Foreign Application Priority Data
Aug. 26, 2011 (KR) 1020110085972

(51) Int. Cl. H02K 5/167

(52) U.S. Cl. 310/425

(57) ABSTRACT

Disclosed herein is a spindle motor including: a shaft insertedly mounted so as to be perpendicular to an upper side portion; a sleeve receiving the shaft therein to thereby rotatably support the shaft and forming a space between the sleeve and the shaft to thereby be spaced apart from the shaft so as not to contact the shaft; a holder having the sleeve mounted in an inner portion thereof and having a lower portion mounted on an upper portion of a plate; and the plate integrally supporting lower portions of the shaft and the sleeve and including connecting parts connecting the holder and the plate to each other and fixing parts fixing positions of the holder and the plate so that a lower surface of the holder is coupled thereto.

### CROSS REFERENCE TO RELATED APPLICATION

This application claims the benefit of Korean Patent Application No. 10-2011-0085972, filed on Aug. 26, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

The present invention relates to a motor and an optical disk drive using the same, and more particularly, to a motor having an improved coupling structure between a holder and a base plate and an optical disk drive using the same.

In the spindle motor according to the prior art, a circuit substrate is mounted on a base plate, and a holder is inserted into a hole formed at a central portion of the base plate to thereby be fixed to the base plate, or the like. In addition, a lower surface of the holder is connected to a separate support plate.

The holder according to the prior art is formed through cutting. As a material of the holder, expensive brass has been mainly used.

Therefore, research into a method capable of reducing a cost at the time of manufacturing a motor has been urgently demanded.

### SUMMARY OF THE INVENTION

The present invention has been made in an effort to provide a spindle motor having an improved coupling structure to reduce a cost.

According to a preferred embodiment of the present invention, there is provided a spindle motor including: a shaft insertedly mounted so as to be perpendicular to an upper side portion; a sleeve receiving the shaft therein to thereby rotatably support the shaft and forming a space between the sleeve and the shaft to thereby be spaced apart from the shaft so as not to contact the shaft; a holder having the sleeve mounted in an inner portion thereof and having a lower portion mounted on an upper portion of a plate; and the plate integrally supporting lower portions of the shaft and the sleeve and including connecting parts connecting the holder and the plate to each other and fixing parts fixing positions of the holder and the plate so that a lower surface of the holder is coupled thereto.

The spindle motor may further include a thrust plate mounted on the plate and under the sleeve.

The holder may have the sleeve mounted in the inner portion thereof, an armature mounted on an outer diameter thereof, and a lower portion formed to be stepped so as to be coupled to the plate.

At least one connecting part and fixing part may be formed.

The fixing part may be disposed between the connecting parts.

Each of the connecting part and the fixing part may be finely adjusted.

### BRIEF DESCRIPTION OF THE DRAWINGS

FIG. 1 is a partial cross-sectional view of a spindle motor according to a preferred embodiment of the present invention; and

FIG. 2 is a partially enlarged view of the spindle motor according to the preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

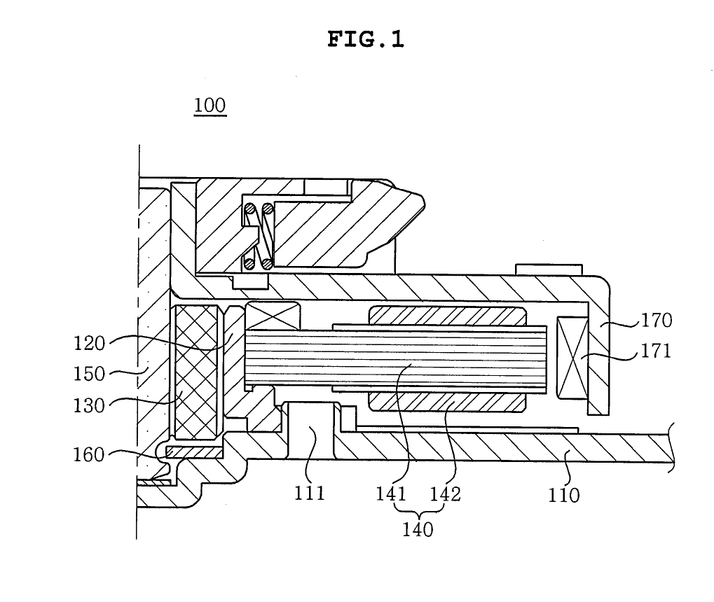

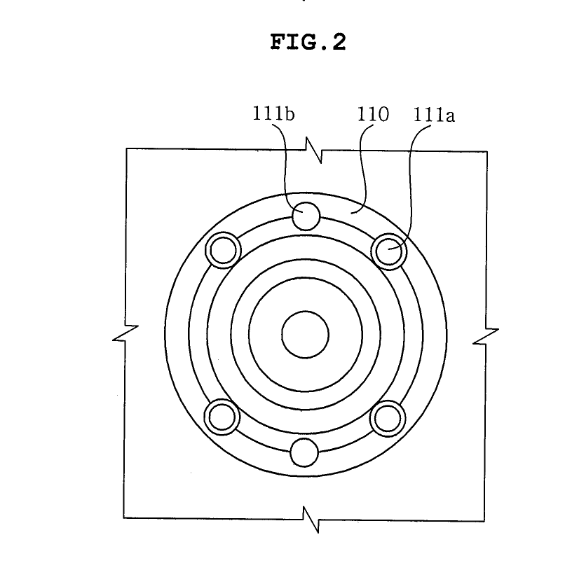

FIG. 1 is a partial cross-sectional view of a spindle motor 100 according to a preferred embodiment of the present invention; and FIG. 2 is a partially enlarged view of the spindle motor 100 according to the preferred embodiment of the present invention.

As shown in FIG. 1, the spindle motor 100 according to the preferred embodiment of the present invention includes a plate 110, a holder 120, a sleeve 130, an armature 140, a shaft 150, a thrust plate 160, and a rotor case 170.

The plate 110, which is to fixedly support the entire spindle motor 100, is fixedly mounted in a device such as an optical disk drive, or the like, having the spindle motor 100 mounted therein. Here, the plate 110 is made of a light weight material such as an aluminum plate, an aluminum alloy plate, or the like. However, the plate 110 may also be made of a steel plate.

In addition, the plate 110 includes a coupling part 111 protruded therefrom, wherein the coupling part 111 includes the holder 120 coupled thereto.

The coupling part 111 includes a connecting part 111a and a fixing part 111b so that the holder 120 is coupled and fixed to an upper surface of the plate 110.

The connecting part 111a and the fixing part 111b are shown in FIG. 2 and will be described below in detail with reference to FIG. 2.

The holder 120, which is to receive the sleeve 130 in an inner portion thereof, is fixedly coupled to the coupling part 111 of the plate 110.

The holder 120 includes a cylindrical body part (not shown) closely adhered to an outer peripheral surface of the sleeve 130 to thereby support the sleeve 130 and a plate support part (not shown) formed to be stepped with respect to the body part (not shown) and support an upper portion of the plate 110.

The sleeve 130, which is to rotatably support the shaft 150, generally has a hollow cylindrical shape and includes an inner diameter part (not shown) facing the shaft 150 and a lower surface (not shown) facing the thrust plate 160.

The armature 140, which is to form an electric field by receiving external power in order to rotate the rotor case 170 having an optical disk or a magnetic disk mounted thereon, is configured of a core 141 formed by stacking a plurality of sheets of thin metal plates and a coil 142 wound many times around the core 141.

The core 141 is fixedly mounted on an outer peripheral surface of the holder and the coil 142 is wound around the core 141. Here, the coil 142 forms an electric field by current applied from the outside thereto to thereby rotate the rotor case 170 by electromagnetic force formed between the coil 142 and a magnet 171 of the rotor case 170.

The shaft 150, which is to support the rotor case 170 in an axial direction, is inserted into the sleeve 130 and is rotatably supported by the sleeve 130.

Meanwhile, the shaft 150 includes the thrust plate 160 disposed on a lower portion thereof, wherein the thrust plate 160 is fixed to the plate 110 disposed under the sleeve 130. Separate laser welding, or the like, may be performed in order to fix the thrust plate 160 to the plate 110. Unlike this, the thrust plate 160 and the plate 110 may be coupled to each other through press-fitting by applying a predetermined pressure to the thrust plate 160.

The rotor case 170, which is to have an optical disk or a magnetic disk (not shown) mounted thereon and rotate the optical disk or the magnetic disk, includes a disk part (not shown) having the shaft 150 fixedly mounted thereto and an annular edge part (not shown) extended from a distal end of the disk part.

The disk part (not shown) includes the shaft 150 fixedly and insertedly coupled to a central portion thereof, and the edge part (not shown) is extended in the axial direction of the shaft 150 so that an inner peripheral surface thereof faces the armature 140 and includes the magnet 171 fixedly mounted to the inner peripheral surface thereof, wherein the magnet 171 forms a magnetic field so as to generate electromagnetic force with the electric field formed in the coil 142.

FIG. 2 is a partially enlarged view of a spindle motor 100 according to a preferred embodiment of the present invention.

FIG. 2 shows that the connecting part 111a connecting the holder 120 to the upper surface of the plate 110 when the holder 120 is coupled to the plate 110 and the fixing part 111b fixing the plate 110 and the holder 120 to each other are formed.

Here, a lower surface of the holder 120 mounted on the upper portion of the plate 110 is extended, and the plate 110 is provided with each of the connecting part 111a and the fixing part 111b so as to be coupled to the lower surface of the holder 120.

The number of connecting parts 111a and fixing parts 111b may be at least one, and the fixing part 111b may be formed between the connecting parts 111a. The connecting part 111a may be connected by various methods and may also be connected by a screw thread, and the fixing part 111b may be fixed by various methods and may be fixed by a method such as a press-fitting method, or the like.

Here, positions at which the connecting part 111a and the fixing part 111b are disposed are not limited. For example, the fixing part 111b may also be formed between the connecting parts 111a.

In addition, since the plate 110 is formed to be stepped to thereby support the lower portions of the shaft 150 and the thrust plate 160 and the lower portion of the holder 120, a separate support plate is not required.

The plate 110 with which a support plate is formed integrally is used without a separate support plate and the plate 110 and the holder 120 are provided with the connecting part 111a and the fixing part 111b, thereby making it possible to control reaction force generated at the time of connecting the plate 110 and the holder 120 to each other.

In addition, each of the connecting part 111a and the fixing part 111b of the plate 110 is finely adjusted differently, thereby making it possible to more firmly and precisely connect the holder 120 to the plate 110.

As set forth above, with the spindle motor 100 according to the preferred embodiment of the present invention, each of the connecting part 111a and the fixing part 111b is formed so that the plate 110 and the holder 120 are coupled to each other, thereby making it possible to control reaction force generated at the time of connecting the plate 110 and the holder 120 to each other.

In addition, since the holder according to the prior art is formed through cutting, expensive brass is mainly used as a material of the holder. On the other hand, according to the preferred embodiment of the present invention, since the expensive brass need not be used, a cost is significantly reduced.

Furthermore, since each of the connecting part 111a and the fixing part 111b of the plate 110 may be finely adjusted differently, the holder 120 may be more firmly and precisely connected to the plate 110.

Although the embodiment of the present invention has been disclosed for illustrative purposes, it will be appreciated that a spindle motor according to the invention is not limited thereby, and those skilled in the art will appreciate that various modifications, additions and substitutions are possible, without departing from the scope and spirit of the invention.

Accordingly, such modifications, additions and substitutions should also be understood to fall within the scope of the present invention.

What is claimed is:

1. A spindle motor comprising:
a shaft insertedly mounted so as to be perpendicular to an upper side portion;
a sleeve receiving the shaft therein to thereby rotatably support the shaft and forming a space between the sleeve and the shaft to thereby be spaced apart from the shaft so as not to contact the shaft;
a holder having the sleeve mounted in an inner portion thereof and having a lower portion mounted on an upper portion of a plate; and
the plate integrally supporting lower portions of the shaft and the sleeve and including connecting parts connecting the holder and the plate to each other and fixing parts fixing positions of the holder and the plate so that a lower surface of the holder is coupled thereto.

2. The spindle motor as set forth in claim 1, further comprising a thrust plate mounted on the plate and under the sleeve.

3. The spindle motor as set forth in claim 1, wherein the holder has the sleeve mounted in the inner portion thereof, an armature mounted on an outer diameter thereof, and a lower portion formed to be stepped so as to be coupled to the plate.

4. The spindle motor as set forth in claim 1, wherein at least one connecting part and fixing part are formed.

5. The spindle motor as set forth in claim 1, wherein the fixing part is disposed between the connecting parts.

6. The spindle motor as set forth in claim 1, wherein each of the connecting part and the fixing part is finely adjusted.
